(19) United States
(12) Patent Application Publication
(10) Pub. No.: US 2013/0270376 A1
(43) Pub. Date: Oct. 17, 2013

(54) Multi-Grater

(71) Applicants: Christopher Hawker, Columbus, OH (US); Jessica Moreland, Columbus, OH (US); Christopher Trunek, Auburn Township, OH (US)

(72) Inventors: Christopher Hawker, Columbus, OH (US); Jessica Moreland, Columbus, OH (US); Christopher Trunek, Auburn Township, OH (US)

(21) Appl. No.: 13/446,507

(22) Filed: Apr. 13, 2012

(51) Int. Cl. A47J 43/25; B25F 1/02

(52) U.S. Cl. 241/101.1; 241/169

(57) ABSTRACT

A multi-grated is disclosed, comprising a volume approximating a tube defining a chute, a substantially planar cutting surface traversing the chute at the ventral end thereof and slideably coupled thereto, wherein the cutting surface has a linear gear disposed thereupon; a lever pivotably coupled to the chute with a radial gear disposed upon the ventral end thereof and complementorily engaged against the linear gear.

### BACKGROUND/FIELD

Devices are disclosed herein configured for processing solid materials by means of manual abrasion and cutting, including for instance the grating of cheese and vegetables.

### SUMMARY

A multi-grater is disclosed herein, the multi-grater comprising a volume approximating a tube defining a chute, a substantially planar cutting surface traversing the chute at the ventral end thereof and slideably coupled thereto, wherein the cutting surface has a linear gear disposed thereupon; a lever pivotably coupled to the chute with a radial gear disposed upon the ventral end thereof and complementorily engaged against the linear gear.

According to further embodiments of the present disclosure, a multi-grater is disclosed comprising two lever—gear pairs disposed upon respective lateral faces of the multi-grater.

According to further embodiments of the present disclosure, a multi-grater is disclosed wherein the two levers are joined at their distal end by a horizontal beam.

According to further embodiments of the present disclosure, a multi-grater is disclosed wherein there is a plunger sized and shaped to substantially accommodate the cross-section of the chute.

According to further embodiments of the present disclosure, a multi-grater is disclosed wherein the linear gear is disposed within a platon which in turn releasably retains the cutting surface.

According to further embodiments of the present disclosure, a multi-grater is disclosed wherein the cutting blades are interchangeable and selected from one of; a course grater, a fine grater, and a zester.

According to further embodiments of the present disclosure, a multi-grater is disclosed wherein there are complementary stops disposed upon the exterior face of chute and the interior face of the lever, thereby defining a limit of the cutting surface's travel.

According to further embodiments of the present disclosure, a multi-grater is disclosed wherein there is a protrusion extending ventrally from the proximal end of the chute sized and shaped to interfere with the proximal face of the cutting surface, thereby defining a limit of the cutting surface's travel.

According to further embodiments of the present disclosure, a multi-grater is disclosed wherein there is a aperture disposed upon the dorsal end portion of the plunger sized and shaped to receive the thumb of an operator therein.

According to further embodiments of the present disclosure, a multi-grater is disclosed wherein there is a substantially rigid sleeve abutting the interior face of the chute.

According to further embodiments of the present disclosure, a multi-grater is disclosed wherein there is a handle portion extending in a substantially proximal direction from the proximal exterior face of the chute.

According to further embodiments of the present disclosure, a multi-grater is disclosed wherein there is an indent in the dorsal medial face of the handle and chute sized and shaped to accommodate the thumb of a user.

According to further embodiments of the present disclosure, a multi-grater is disclosed wherein the portion of the chute to which the lever in hinged, is itself removable coupled to the remainder of the chute defining a nosepiece.

According to further embodiments of the present disclosure, a multi-grater is disclosed wherein the nosepiece is coupled to the chute by way of a sliding tab disposed on the dorsal portion thereof and a fixed tab on the ventral portion thereof which may be complementorily inserted into corresponding recesses in chute.

According to further embodiments of the present disclosure, a multi-grater is disclosed wherein the chute and lever are composed of thermoplastic resins.

According to further embodiments of the present disclosure, a multi-grater is disclosed wherein the chute and lever are formed by injection molding.

According to further embodiments of the present disclosure, a multi-grater is disclosed wherein the cross-section of the chute is substantially rectangular.

According to further embodiments of the present disclosure, a multi-grater is disclosed wherein the ventral face of the plunger is removably coupled to the remainder of the plunger by means of press-fitting.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows an isometric view of an embodiment of a multi-grater.

FIG. 2 shows an exploded isometric view thereof.

FIG. 3 shows an isometric view of a body.

FIG. 4 shows an exploded view of a cutting surface.

FIG. 5 shows an isometric view of a lever.

FIG. 6 shows an exploded isometric view of a nose-piece.

FIG. 7 shows an isometric view of a sleeve.

FIG. 8 shows an exploded isometric view of a plunger.

FIG. 9 shows an isometric view of a further embodiment of a multi-grater.

FIG. 10 shows an isometric view of a further embodiment of a handle.

### DETAILED DESCRIPTION EXEMPLARY EMBODIMENT SHOWN IN THE FIGURES

Various embodiments of the presently disclosed apparatus will now be described in detail with reference to the drawings, wherein like reference numerals identify similar or identical elements. In the drawings and in the description that follows, the term “proximal,” will refer to the end of a device or system that is closest to the operator, while the term “distal” will refer to the end of the device or system that is farthest from the operator. Likewise, anatomical terms of location shall have their accepted relative meanings.

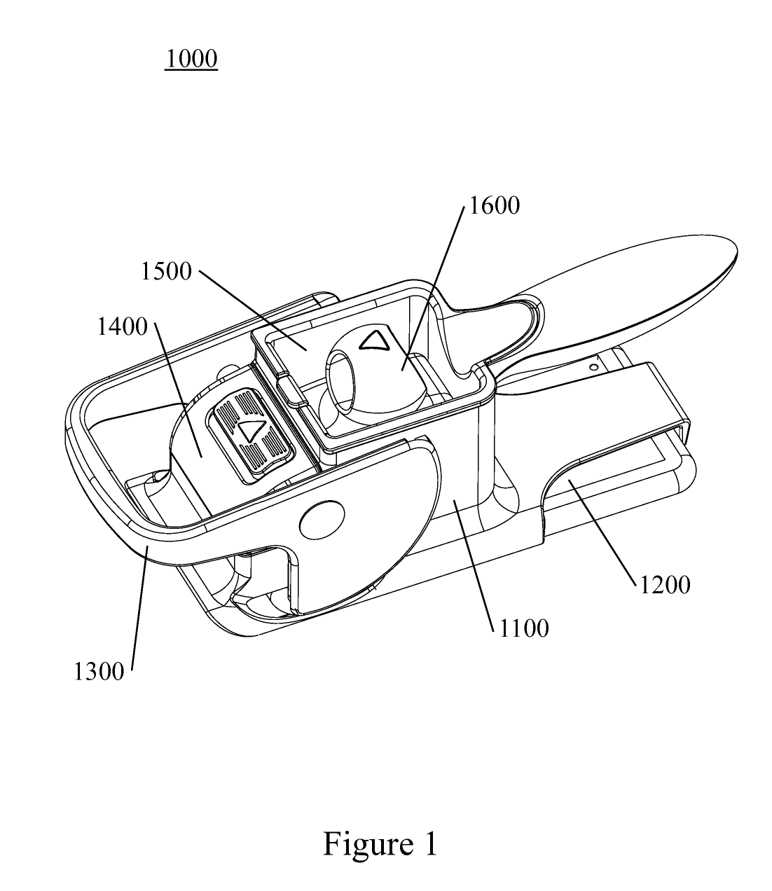

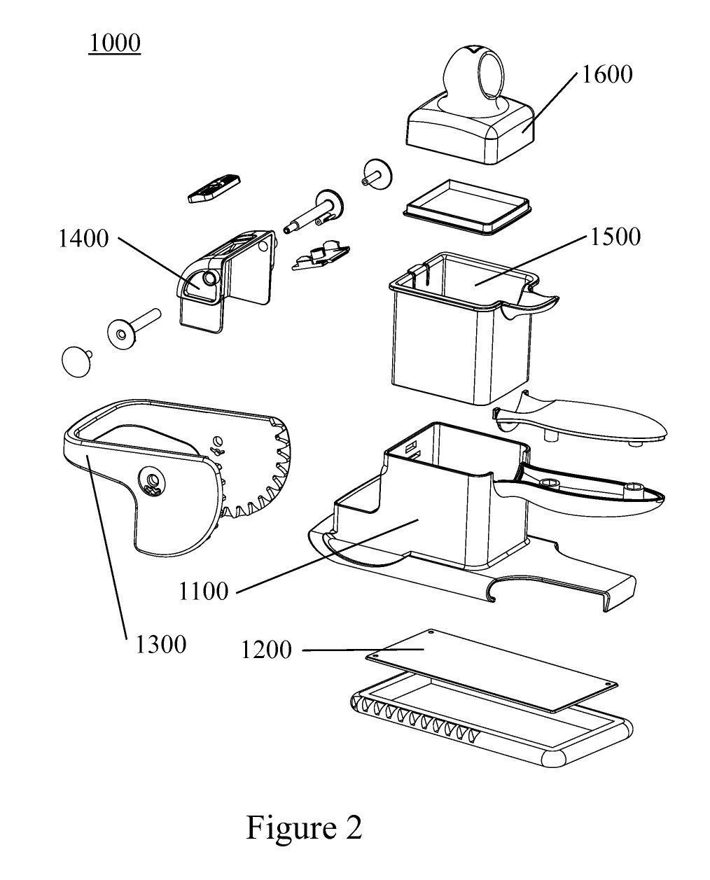

Referring to FIGS. 1 and 2 together, a multi-grater 1000 is shown having a grater body 1100, a cutting surface 1200, a lever 1300, a nose-piece 1400, a sleeve 1500, and a plunger 1600.

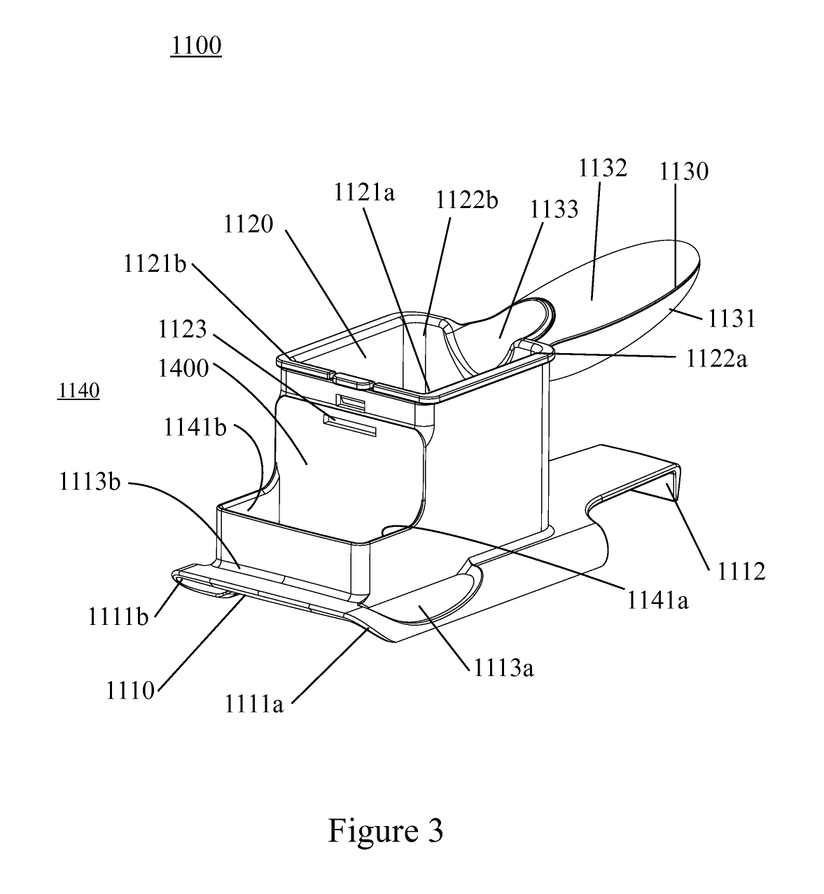

Referring now to FIG. 3 and progressing dorsally, body 1100 has a substantially planar ventral face 1110 disposed upon the ventral portion thereof, with complementary lateral hooks 1111(a and b) disposed upon opposing sides of face 1110 and operatively configured to slideably retain cutting surface 1200 therein. There is a clip stand 1112 extending ventrally from the proximal end portion of face 1110 and operatively configured to provide a proximal-end stop for the motion of cutting surface 1200 as well as a ventral support for the assembled device. There are complementary arcuate gear recesses 1113(a and b) disposed upon the distal end portions of respective hooks 1111(a and b) and operatively configured to allow the radial motion of lever 1300 therein.

There is a chute body 1120 extending dorsally from face 1110 and having a substantially rectangular cross-section. According to one embodiment of the present disclosure, the proximal most corners 1121(a and b) of chute 1120 have a first radius Θ1 and the distal-most corners 1122(a and b) have a second radius Θ2 such that sleeve 1500 and plunger 1600 may only be inserted into chute 1120 in one orientation. There is a lateral slit 1123 disposed upon the distal face of chute 1120 and operatively configured to receive a complementary lateral pin disposed upon sleeve 1500 therein.

There is a handle 1130 extending proximally from the proximal face of chute 1120 that is sized and shaped to be comfortably grasped by the hand of an operator. Handle 1130 is itself comprised of two portions 1131, which extends from chute 1120 and 1132 which is a distinct component. Portion 1132 has a substantially elliptical detent 1133 disposed upon the distal end thereof, sized and shaped to receive the thumb of an operator.

Referring still to FIG. 3, there is a receiver 1140 disposed upon the distal-most portion of body 1100 that is operatively configured to removably retain nose-piece 1400 therein. Opposing lateral faces 1141(a and b) are sized and shaped to receive complementary tabs disposed upon nose-piece 1400, and the distal-most face of chute 1120 has recesses disposed thereon to receive complementary structures disposed upon nose-piece 1400.

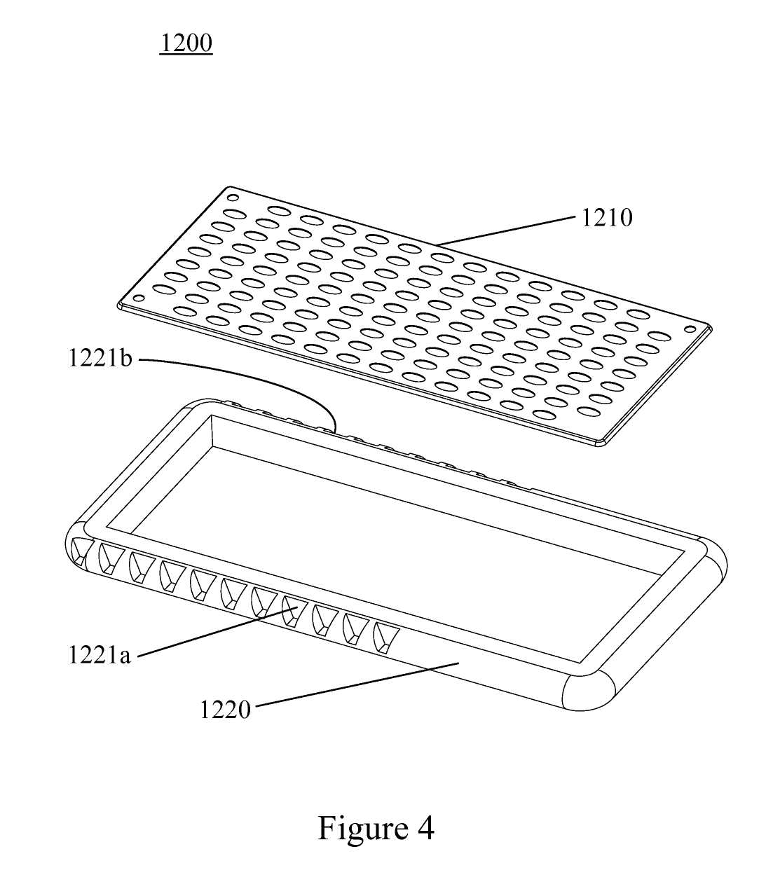

Referring now to FIG. 4, cutting surface 1200 is itself comprised of two components, a cutting plane 1210, and a platon 1220. Cutting plane 1210 is an abrasive surface selected from a fine grater, a course grater, a slicer, a julienne cutter, a wave-cutter, a crinkle cutter, a zester, or other moving cutting surface known in the cooking arts. Cutting plane 1210 is retained within platon 1220 by means of press-fitting, snap-fitting, co-molding, over-injection, or adhesive. Platon 1220 is a substantially planar member having to lateral, parallel linear gear trains 1221(a and b) disposed on opposing sides thereof.

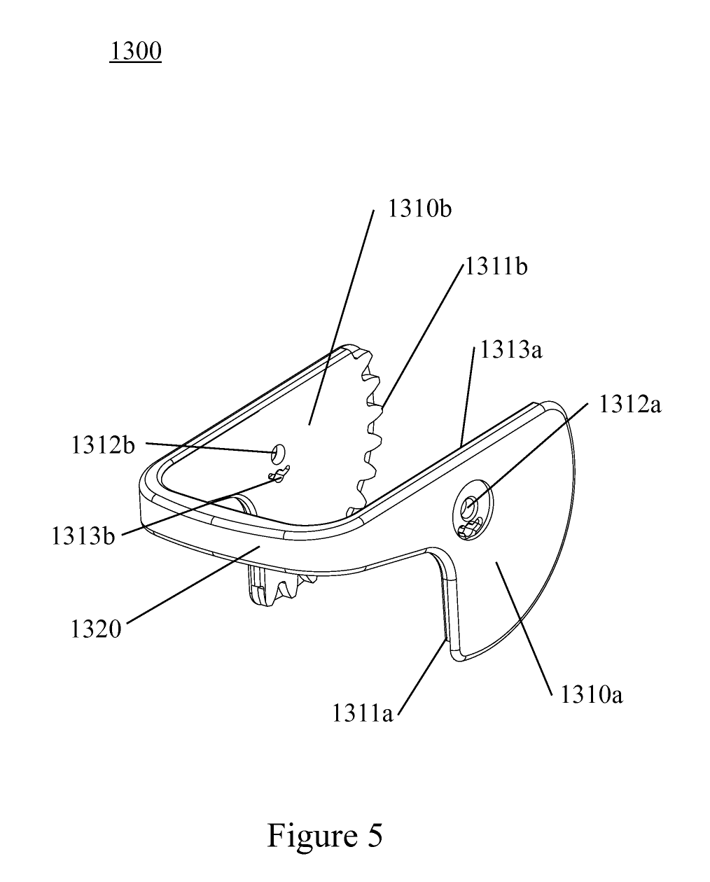

Referring now to FIG. 5, lever 1300 is shown. Lever 1300 has substantially chiral paddles 1310(a and b) disposed upon the proximal-end portions thereof. With paddles 1310(a and b) each having a radial gear train 1311(a and b) disposed upon the periphery thereof and sized and shaped to be engaged against linear gear train 1221(a and b). Paddles 1310(a and b) further have co-axial apertures 1312(a and b) sized and shaped to be pivotably retained against a complementary aperture disposed upon nose-piece 1400. There are stops 1313(a and b) disposed upon the medial faces of paddles 1310(a and b) which interfere with complementary structures disposed upon nose-piece 1400 thereby defining a distal-most limit to the travel of lever 1300. Paddles 1310(a and b) are joined at the distal-end portion thereof by a bridge 1320.

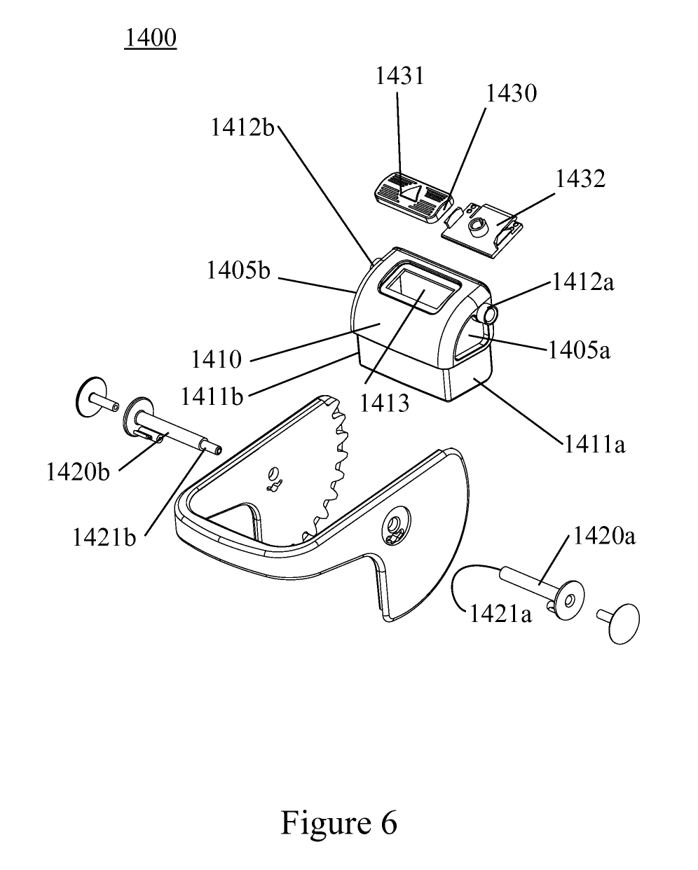

Referring now to FIG. 6, a nose-piece assembly 1400 is shown. Nose-piece 1400 is comprised of a body 1410, pins 1420(a and b), and a slide 1430. Body 1410 has tabs 1411(a and b) extending ventrally therefrom and operatively configured to be removably snap-fitted to lateral faces 1141(a and b). There are co-axial apertures 1412(a and b) disposed upon opposing sides of body 1410 and arranged to receiving pins 1420 therein. There is a recess 1413 disposed upon the dorsal face of body 1410 sized and shaped to allow distal-proximal motion of slide 1430 therein.

According to certain embodiments of the present disclosure, as show in FIG. 6, Slide 1430 is comprised of two components, a slide face and a slide holder. Slide face and slide holder are complementary, substantially planar members operatively configured to be coupled to on another by means of snap-fitting, press-fitting, co-molding, over-injection, or adhesive.

Pins 1420(a and b) are elongated, substantially cylindrical members having enlarged heads disposed upon the lateral portion thereof and complementary male and female couplings 1421(a and b) disposed upon the medial ends thereof. Upon assembly, pins 1420(a and b) traverse apertures 1412(a and b) and 1312(a and b) and have their respective male and female couplings engaged against one another.

Referring now to FIGS. 5 and 6 together, a further embodiment of the present disclosure is shown wherein there are corresponding keyed apertures 1313(a and b) disposed upon respective opposing paddles 1310(a and b). There are keys 1421(a and b) projecting medially from the heads of pins 1420(a and b). Further, there is are complementary recesses 1405(a and b) disposed upon opposing lateral faces of nosepiece 1400. Upon assembly, keys 1421(a and b) extend through apertures 1313(a and b) and into recesses 1405(a and b). Such an arrangement removably fixes the components in their relative orientations.

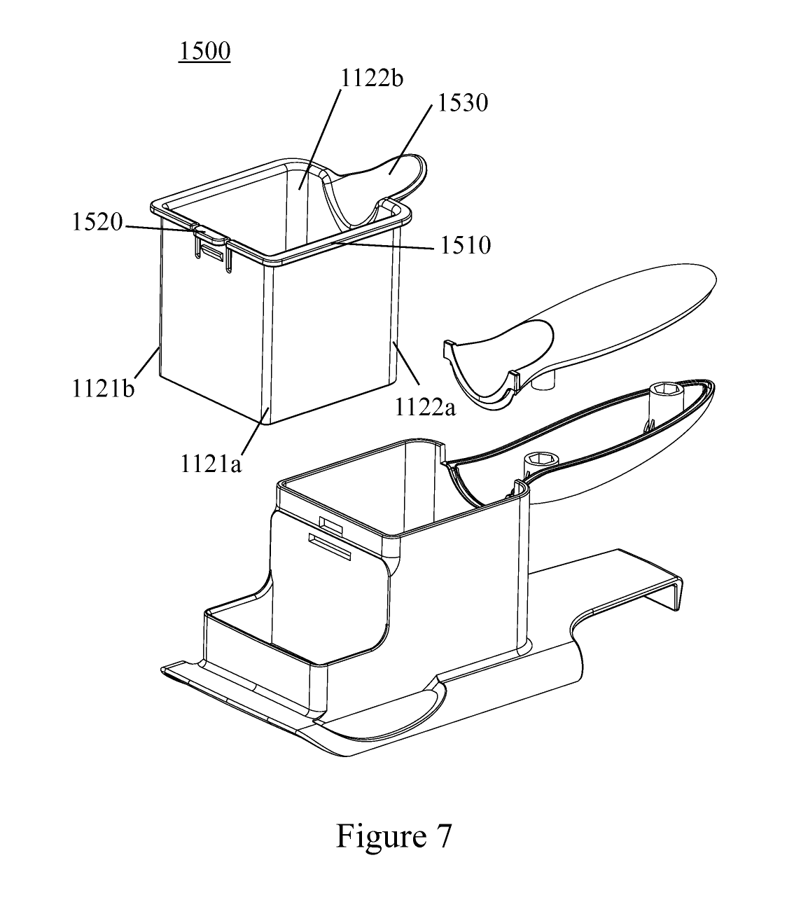

With reference to FIG. 7, a sleeve 1500 is an annular member having a substantially rectangular profile keyed to the corners 1121(a and b) and 1122(a and b) such that it may be inserted into chute 1120 in only one orientation. There is a lip 1510 disposed upon the dorsal end of chute 1120 defining the depth to which it can be inserted into chute 1120. There is a deformable tab 1520 disposed upon the distal face of sleeve 1500 sized and shaped to complementorily engage lateral slit 1123 of chute 1120. There is a bend 1530 disposed upon the proximal-ventral end of sleeve 1500 sized and shaped to rest within detent 1133 of handle 1130.

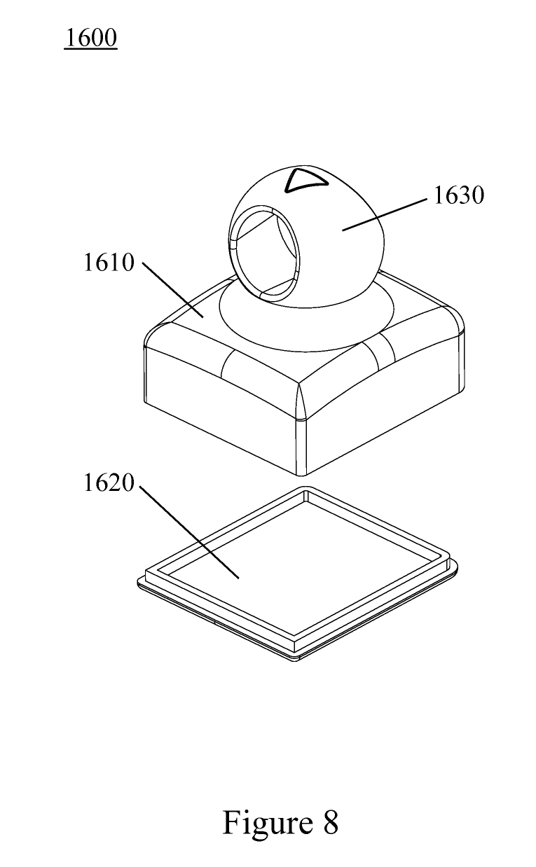

Referring now to FIG. 8, plunger 1600 is shown. Plunger 1600 is comprised of a plunger body 1610, a ventral plate 1620, and a thumb aperture 1630. Body 1610 has a substantially rectangular cross-section sized and shaped for motion within sleeve 1500. The ventral-end portion body 1610 is sized and shaped to retain plate 1620 therein by means of press-fitting, snap-fitting, ultrasonic assembly, or an adhesive. The ventral face of plate 1620 may have a modified surface finish including patterns detents or embosses configured for holding food thereagainst. Thumb aperture 1630 is a substantially cylindrical aperture disposed upon the dorsal end of body 1610. Aperture 1620 is angled such that the distal end of the aperture is disposed ventrally relative to the proximal end of the aperture.

A method of using the exemplary embodiment of the present disclosure will now be described. First, a multi-grater is provided in a first state, as shown for instance in FIG. 1. An operator removes plunger 1600 from sleeve 1500 and place an object to be abraded, including for instance a portion of cheese therein. Next, the operator, inserts plunger 1600 into sleeve 1500 abutting plate 1620 against the portion of cheese. Next, the user grasps the handle 1130 in their first hand, with the thumb of the first hand disposed in aperture 1630 and providing ventral pressure against the portion of cheese. Next, the operator grasps bridge 1320 in their second hand and translates it radially first clockwise to its first limit, then counter-clockwise to its second limit. This motion consequently engages radial gear train 1311(a and b) against linear gear train 1221(a and b) thereby causing motion of cutting surface 1200 relative to the portion of cheese and abrading the cheese.

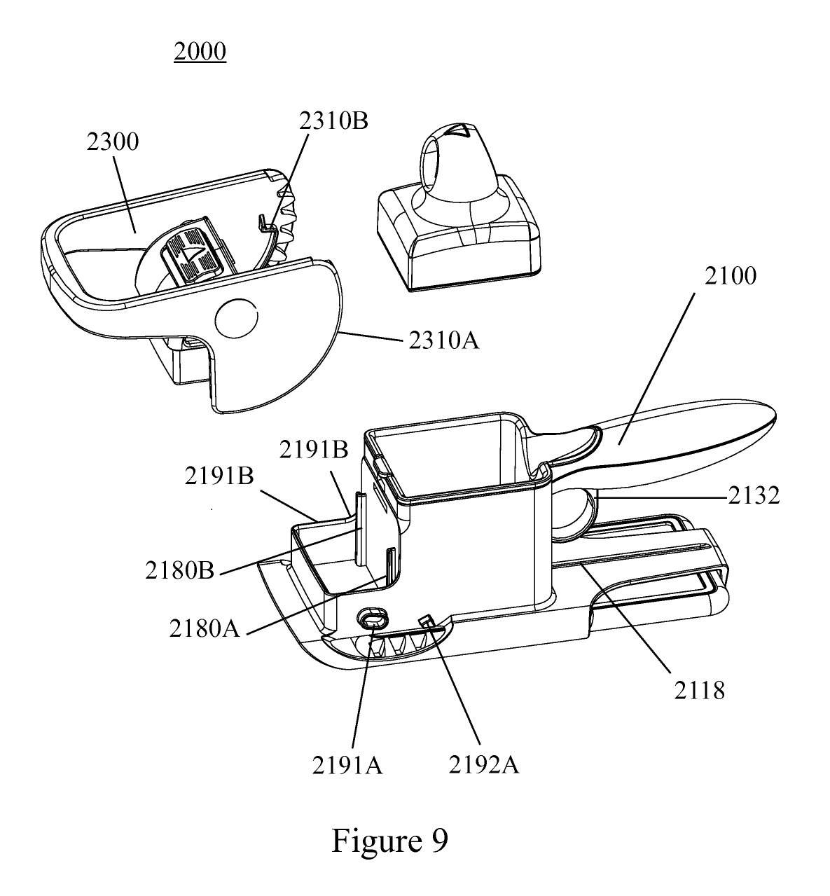

According to FIG. 9 of the present disclosure, a further embodiment 2000 of a multi-grater is shown. Handle 2300 of multi-grater 2000 has a pair of substantially arcuate tracks 2310(A and B) disposed on opposing faces thereof. Tracks 2310(a and b) provide a bearing surface upon which complimentary protrusions 2191(a and b) and 2192(a and b) disposed upon body 2100 may glide. Further, there is a stop disposed upon the dorsal ends tracks 2310(a and b) which interferes with the stops thereby defining the range of handle 2300's motion relative to body 2100.

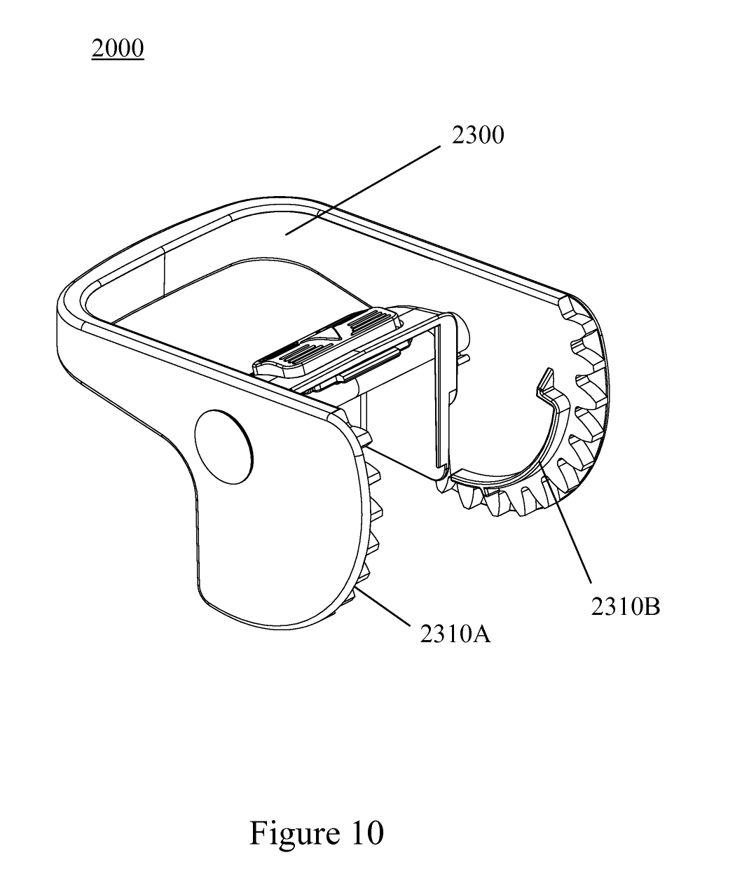

With continued reference to FIG. 9 and FIG. 10, there are complementary opposing rails 2180(a and b) disposed within the distal-end portion of body 2100 operatively configured to mediate the travel of the nose-portion of the device therein.

Further, there is a finger hole 2132 disposed dorsally from the handle of body 2100. Finger hole 2132 is operatively configured to provide additional stability and grip for a user when grasping the device. There is a strengthening ridge 2118 disposed upon the surface of the proximal-end portion of body 2100. Ridge 2118 may be either a recess or protrusion which operates to stiffen its surrounding structure against flexion.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A multi-grater comprising;
a volume approximating a tube defining a chute,
a substantially planar cutting surface traversing the chute at the ventral end thereof and slideably coupled thereto, wherein the cutting surface has a linear gear disposed thereupon;
a lever pivotably coupled to the chute with a radial gear disposed upon the ventral end thereof and complementorily engaged against the linear gear.

2. The multi-grater of claim 1, wherein there two lever-gear pairs disposed upon respective lateral faces of the multi-grater.

3. The multi-grater of claim 2, wherein the two levers are joined at their distal end by a horizontal beam.

4. The multi-grater of claim 1, there is a plunger sized and shaped to substantially accommodate the cross-section of the chute.

5. The multi-grater of claim 1, wherein linear gear is disposed within a platon which in turn releasably retains the cutting surface.

6. The multi-grater of claim 1, wherein the cutting blades are interchangeable and selected from one of; fine grater, a course grater, a slicer, a julienne cutter, a wave-cutter, a crinkle cutter, a zester, or other moving cutting surface known in the cooking arts.

7. The multi-grater of claim 1, wherein there are complementary stops disposed upon the exterior face of chute and the interior face of the lever, thereby defining a limit of the cutting surface's travel.

8. The multi-grater of claim 1, wherein there is a protrusion extending ventrally from the proximal end of the chute sized and shaped to interfere with the proximal face of the cutting surface, thereby defining a limit of the cutting surface's travel.

9. The multi-grater of claim 4, wherein there is a aperture disposed upon the dorsal end portion of the plunger sized and shaped to receive the thumb of an operator therein.

10. The multi-grater of claim 1, wherein there is a substantially rigid sleeve abutting the interior face of the chute.

11. The multi-grater of claim 1, wherein there is a handle portion extending in a substantially proximal direction from the proximal exterior face of the chute.

12. The multi-grater of claim 11, wherein there is an indent in the dorsal medial face of the handle and chute sized and shaped to accommodate the thumb of a user.

13. The multi-grater of claim 1, wherein the portion of the chute to which the lever in hinged, is itself removable coupled to the remainder of the chute defining a nosepiece.

14. The multi-grater of claim 13, wherein nosepiece is coupled to the chute by way of a sliding tab disposed on the dorsal portion thereof and a fixed tab on the ventral portion thereof which may be complementorily inserted into corresponding recesses in chute.

15. The multi-grater of claim 1, wherein the chute and lever and composed of thermoplastic resins.

16. The multi-grater of claim 1, wherein the chute and lever are formed by injection molding.

17. The multi-grater of claim 1, wherein the cross-section of the chute is substantially rectangular.

18. The multi-grater of claim 4, wherein the ventral face of the plunger is removably coupled to the remainder of the plunger by means of press-fitting.

19. A multi-grater comprising;
a volume approximating a tube defining a chute,
a substantially planar cutting surface traversing the chute at the ventral end thereof and slideably coupled thereto, wherein the cutting surface has a linear gear disposed thereupon;
a lever pivotably coupled to the chute with a radial gear disposed upon the ventral end thereof and complementorily engaged against the linear gear,
wherein linear gear is disposed within a platon which in turn releasably retains the cutting surface.

20. A multi-grater comprising;
a volume approximating a tube defining a chute,
a substantially planar cutting surface traversing the chute at the ventral end thereof and slideably coupled thereto, wherein the cutting surface has a linear gear disposed thereupon;
two laterally disposed levers pivotably coupled to opposing exterior faces of the chute with a radial gear disposed upon the ventral end thereof and complementorily engaged against the linear gear,
wherein linear gear is disposed within a platon which in turn releasably retains the cutting surface.
